(19) United States
(12) Patent Application Publication
(10) Pub. No.: US 2026/0017587 A1
(43) Pub. Date: Jan. 15, 2026

(54) WORKFLOW GENERATOR TOOL FOR DATA EXTRACTION

(71) Applicant: The PNC Financial Services Group, Inc., Pittsburgh, PA (US)

(72) Inventors: Scott P. Kinross, Severna Park, MD (US); Steven A. Lettieri, Pittsburgh, PA (US); Eric S. Ayeh, Denton, TX (US); Ilana Y. Kanal, Pittsburgh, PA (US)

(21) Appl. No.: 18/768,655

(22) Filed: Jul. 10, 2024

(51) Int. Cl. G06Q 10/0631; G06F 8/65; G06Q 10/0633

(52) U.S. Cl. CPC G06Q 10/06316; G06F 8/65; G06Q 10/0633

(57) ABSTRACT

A system and method to extract data from documents. The system comprising a data extraction server and a web server in communication with a requesting application of an enterprise, a downstream application of the enterprise, and the data extraction server, the web server to provide a web-based user interface to receive configuration settings from an administrator of the enterprise, the web server comprising a workflow generator to automatically generate an executable code based on the configurations settings received by the web-based user interface.

### BACKGROUND

Document processing by an enterprise can consume significant resources. In certain instances, an enterprise may process the same document several times. Certain financial transactions, such as loan origination for a home equity line or an credit line for a mortgage, for example, include multiple steps and multiple stakeholders who may require data from the same documents in different formats and/or at different times in the process. For example, different systems may require information from a customer's W-2; however, the systems may need different information and/or the same information in different formats and/or may use the information in different ways.

### SUMMARY

In one general aspect, the system includes a data extraction server to extract data from documents. The system also includes a web server in communication with a requesting application of an enterprise, a downstream application of the enterprise, and the data extraction server, the web server to provide a web-based user interface to receive configuration settings from an administrator of the enterprise. The web server includes a workflow generator to automatically generate an executable code based on the configurations settings received by the web-based user interface, the executable code to: receive, from the requesting application, an image of a document; classify the document as one of a plurality of document classification types; transmit the document and document classification type to the data extraction server; receive, from the data extraction server, extracted data based on the document and document classification type; and publish the extracted data via a subscription service to the downstream application.

In another general aspect, the method includes receiving, from a web-based user interface of a web server, configuration settings may include a plurality of document classification types and a predetermined confidence threshold for each document classification type; automatically generating, by a workflow generator of the web server, an executable code for a workflow based on the configurations settings received by the web-based user interface input, the executable code for the workflow to: receive, from the requesting application, an image of a document; classify the document as one of said plurality of document classification types; transmit, to a data extraction server, the image of the document and document classification type; receive, from the data extraction server, extracted data from the document; and publish the extracted data via a subscription service to a downstream application.

In another general aspect, the method includes managing, via a web-based user interface, a plurality of document classifications for documents may include extractable data, where managing the plurality of document classifications may include selecting at least one document type associated with each of the plurality of document classifications; managing, via the web-based user interface, a plurality of data extraction rules for the plurality of document classifications; managing, via the web-based user interface, a workflow may include a first data extraction rule of the plurality of data extraction rules, where the workflow may include an API endpoint; managing, via the web-based user interface, a plurality of validations for the workflow; and automatically generating, via a web server, a containerized executable code for the workflow based on the plurality of validations.

### BRIEF DESCRIPTION OF THE FIGURES

Various embodiments of the present invention are described herein by way of example in conjunction with the following figures.

FIG. 1 is a diagram depicting a system for extracting data from documents, the system includes a workflow generator tool communicably coupled to a requesting application, a downstream application via a data stream, and a data extraction platform, according to various aspects of the present disclosure.

FIGS. 2A-2I are data extraction flowcharts, according to various aspects of the present disclosure.

FIGS. 3A-3F are data extraction flowcharts including a human-in-the-loop module, according to various aspects of the present disclosure.

FIG. 4 is a diagram depicting a method to automatically generate an executable code for a workflow, according to various aspects of the present disclosure.

FIG. 5 is a portion of a web-based user interface for the workflow generator tool of FIG. 1, depicting configuration modules for a workflow, according to various aspects of the present disclosure.

FIG. 6 is a portion of a web-based user interface for the workflow generator tool of FIG. 1, depicting a post-validation processing tool, according to various aspects of the present disclosure.

FIG. 7 is a portion of a web-based user interface for the workflow generator tool of FIG. 1, depicting a visual identification image extraction tool, according to various aspects of the present disclosure.

FIG. 8 is a portion of a web-based user interface for the workflow generator tool of FIG. 1, further depicting a human-in-the-loop user validation interface and FIG. 8A is a detail view of part of the portion of the web-based user interface of FIG. 8, according to various aspects of the present disclosure.

### DETAILED DESCRIPTION

A workflow generator tool to manage the end-to-end document journey can streamline document processing by the enterprise. Machine learning models can be built, which classify documents into different document classification types and/or extract text and/or image data from the document. Different document types can utilize different extraction models. The workflow generator tool can leverage machine learning models. The workflow generator tool can include configuration modules based on customizable configuration settings. Output of the machine learning models can be displayed based on the configuration settings. For example, particular data fields can be displayed for specific business purposes according to the configuration settings for a particular configuration module.

The workflow generator tool can be scalable. For example, after the machine learning models are built, configuration modules can be added and/or modified based on new products and/or services being offered by the enterprise and/or new document types.

The customer can submit a document, or multiple documents, and receive real-time feedback of acceptance of the document(s) as data is extracted and directly broadcast to and/or consumed by a downstream application.

In certain instances, multiple documents can be submitted together. In such instances, the batch or package of documents can be unbundled and individually submitted to the appropriate model based on the customized configuration settings and/or the document's classification.

The workflow generator can leverage a touch-it-once principle to preserve resources expended on redundant document processing.

The workflow generator tool can allow for the workflow(s), user interface component(s), and/or extraction rules to be set up as administrative features as opposed to writing new source code. Where configuration settings are abstracted and agnostic to data extraction platform, systems, tools, and models, the document processing workflows can be set up through a series of configuration settings and without an administrator needing to write any lines of code. In such instances, when the extraction rules require a change (e.g. different data is required or a different format or source for the data is provided), the administrator can manage the extraction rules via the workflow generator tool, rather than hard coding the change into a code base, for example. The web-based user interface can be used to specify a business process and the particular data extraction rules therefor. Moreover, new document types and/or processes can be seamlessly and/or quickly onboarded by the enterprise.

In various instances, the workflow generator can support the System of Record (SOR) for the enterprise. The SOR can be any system that the enterprise designates as a SOR for a particular application. For example, the output from the web-based web server implementing executable software generated by the workflow generator tool can provide data to a SOR database and/or can compare output data from the workflow generator tool to the SOR data for the enterprise and/or a particular application thereof.

The workflow generator can configure one or more of the following features: the creation of workflows (and subsequent automatic generation of API endpoints for document submission and extraction result retrieval), thresholds of confidence for straight-through processing or human-in-the-loop processing, post-extraction, or post-validation, processing rules, validation field comparison rules, grouping of fields for a human-in-the-loop user interface, format and layout (including color, for example) of field grounds, form field validation rules, visual identification of image extraction elements based on an anchor image or text, and/or the ability to bypass extractions and process directly to a manual human-in-the-loop process in the event the data extraction service or tool is unavailable, for example.

The configuration settings for workflow modules are setup via a web-based user interface. For example, the administrative can manage the document classification types and data extraction therefrom. Each document classification type can be associated with one or more documents, which can be selected from a drop-down menu or manually entered by the administrative user. Extractions are managed by administrators at the institution.

Post-validation processing can be used in instances in which a field needs to be processed post-validation. Post-validation configuration settings can comprise a list of dictionaries, such as date reformatting, currency reformatting, and/or removal of certain digits, letters, whitespace, and/or punctuation, for example.

In various instances, the workflow generator tool can be a containerized application that automatically generates an executable code based on configuration settings input into a web-based user interface. A containerized application runs in isolated runtime environments called containers. Containers encapsulate an application with all its dependencies, including system libraries, binaries, and configuration files. The all-in-one packaging of a containerized application makes it portable by enabling it to behave consistently across different hosts—allowing developers to write once and run almost anywhere. Containers generally do not include their own operating systems (OS). Different containerized applications running on a host system, instead, share the existing OS provided by that system. Without any need to bundle an extra OS along with the application, containers are extremely lightweight and can launch very quickly. To scale an application, more instances of a container can be added almost instantaneously. In various instances, a pod of containerized codes can be added together for scalability.

A workflow generator tool at a web-based server can package the automatically-generated code and transmit the package (e.g. a pod of containerized code) to an end user and/or application at the enterprise. The response can comprise a file, a class (e.g., an extensible program-code-template for creating objects), and/or code, for example.

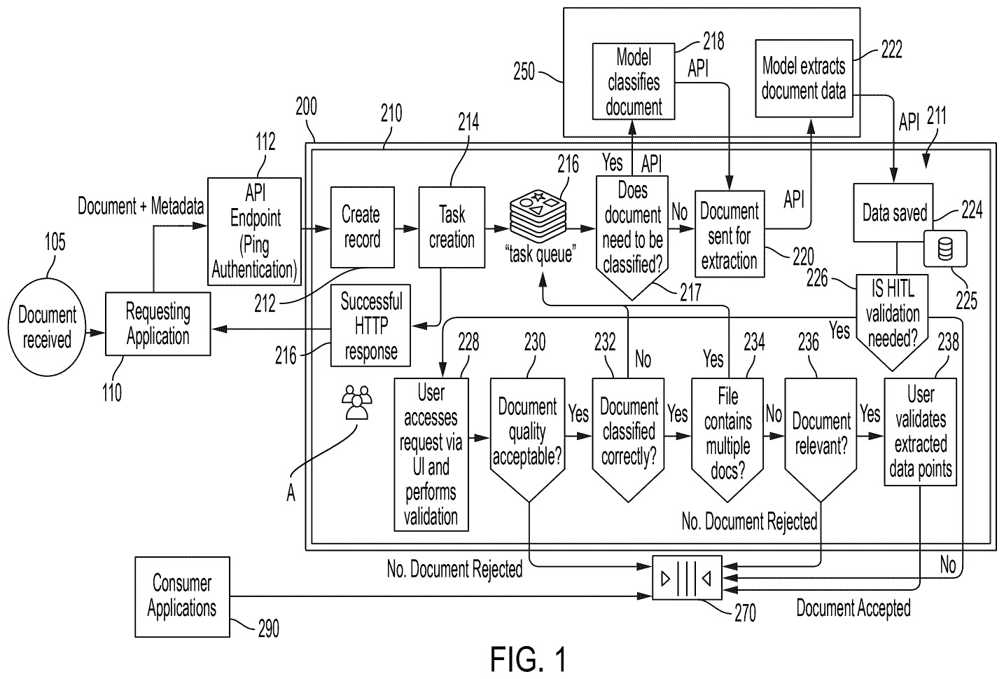

Referring now to FIG. 1, a system 100 for an enterprise to extract data from documents is depicted schematically. The system 100 includes a web-based server 200 including a workflow generator tool 210 communicably coupled to a requesting application 110 of the enterprise, a downstream application 290 of the enterprise via a data stream publisher 270, and a data extraction platform 250. The workflow generator tool 210 generates a workflow 211 including API endpoints for communicating with the requesting application 110, the data extraction platform 250, and/or the data stream publisher 270.

The workflow generator tool 210 automatically generates executable code for data extraction. In various instances, the web-based server 200 is further to run the executable code to extract data from the document based on configuration settings input at a web-based user interface provided by the web-based sever 200. In other instances, a remote server and/or local server to the enterprise can run the executable code to extract the data.

The workflow generator tool 210 is to automatically generate API endpoints based on the configurations settings to the web-based user interface. In such instances, executable code can comprise executable code for the API endpoints. In various instances, the executable code comprises executable code for a first API endpoint to transmit a confirmation response to the requesting application upon receipt of the document and for a second API endpoint to publish the extracted data via a subscription service to one or more downstream applications. The foregoing API endpoints are exemplary; additional API endpoints are contemplated and depicted in the workflows further disclosed herein.

The data extraction platform 250 comprises an extraction server to extract data from documents, such as the document 105 initially received by the enterprise and provided to the requesting application 110. The data extraction platform 250 can be remote and independent of the enterprise or internally operated and/or managed by the enterprise. One such data extraction server is operated by Indico Data Solutions, Inc., for example; however, alternative data extraction models and services are contemplated. The workflow generator tool 210 is extraction platform agnostic; it can leverage various data extraction platforms. More specifically, the configuration settings managed by the administrator via the workflow generator tool and web-based user interface therefor are configurable for use with a number of suitable data extraction platforms. The suitable data extraction platform can be selected based on the particular business purpose for the data extraction.

The web-based server 200 is communicably coupled to a memory storing configuration settings, which can be input by an administrator via a web-based user interface, to generate a workflow. The configuration settings can comprise document classification types and one or more extraction rules for each document classification type.

In various instances, upon receipt of updated configuration settings from the web-based user interface, the work flow generator is to automatically update the executable code. For example, the executable code can be revised based on updated configuration settings provided by an administrator. Updating the executable code is automated. In other words, the executable code for a workflow is updated without requiring an administrator to edit and/or rewrite the code for the workflow.

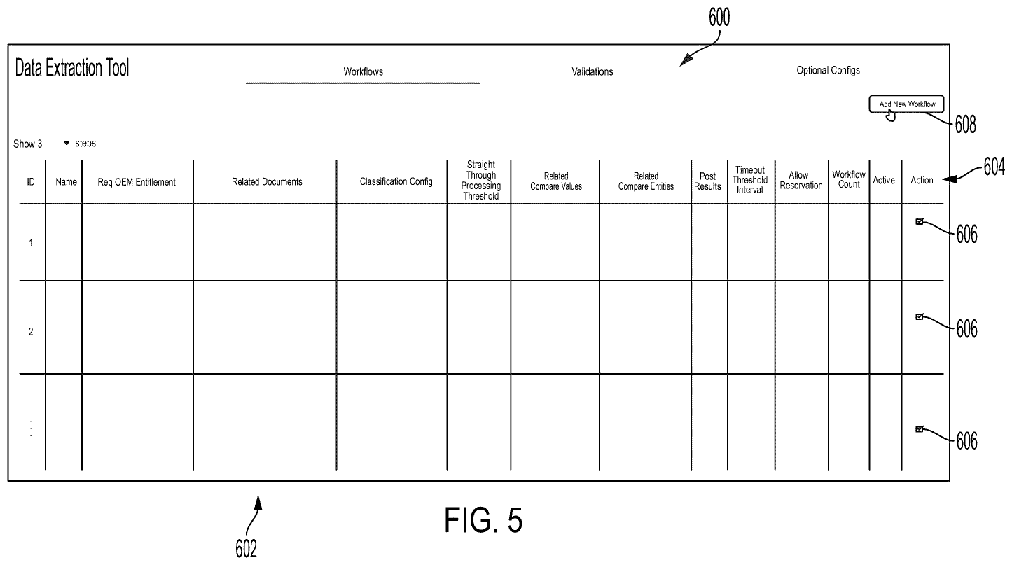

The web server 200 provides a web-based user interface to receive configuration settings from an administrator of the enterprise. Exemplary web-based user interfaces are depicted in FIGS. 5-8, for example. The workflow generator tool 210 is to automatically generate the workflow 211, which is comprised of executable code based on configurations settings received at the web-based user interface from an administrator. Customization of the configuration settings corresponding to the data extraction rules for each specific workflow is further described herein. In various instances, the workflow generator tool 210 automatically generates a containerized code for a containerized application. In certain instances, the executable code automatically generated by the workflow generator tool 210 is written in either Python or JavaScript, for example.

In various instances, the enterprise includes a document upload tool to obtain an image of the document and to upload the image of the document and metadata associated with the document for the requesting application 110. In various instances, a document can be physically or digitally scanned by the enterprise. The requesting application 110 obtains the image and associated metadata and transmits the image and associated metadata to the web server 200 via an API endpoint 112. The workflow generator tool 210 generates the workflow 211 to receive the image and associated metadata for the document 105. Upon receipt of the image/metadata for the document 105 via the API endpoint 112 generated by the workflow generator tool 210, the workflow 211 comprises record creation 212 to create a record for the document, and task creation 214 to create an extraction task for the document. The workflow 211 further comprises HTTP responder 216 for providing feedback to the requesting application 110. For example, the feedback can indicate whether or not the document was successfully transmitted (e.g. uploaded) to the web-based server 200.

In certain instances, the document upload tool can facilitate bulk document uploads. For example, multiple documents can be selected for uploading. For successfully received and uploaded documents, the workflow 211 proceeds to a task queuer 216. For instances in which a document file includes multiple documents, the task queuer 216 stores a queue of tasks, where each task can correspond to extraction for each document within the file.

The workflow 211 further proceeds to a classification determinator 217, which determines whether or not a document needs to be classified. In various instances, the document classification type can be identified in the metadata and/or can be manually input by the administrator upon transmission of the document from the requesting application. In other instances, classification of the document can be required. In instances where classification is needed, the document is transmitted to the data extraction platform 250 for processing. An API can communicably couple the web-based server 200 to the data extraction platform 250 for document classification, for example. The data extraction platform 250 comprise a classifier 218 and an extractor 222, which are to classify (via the classifier 218) and extract data (via the extractor 222) from the document 105 based on the configuration settings input by a user, which are reflected in the code implementing the workflow 211, for example.

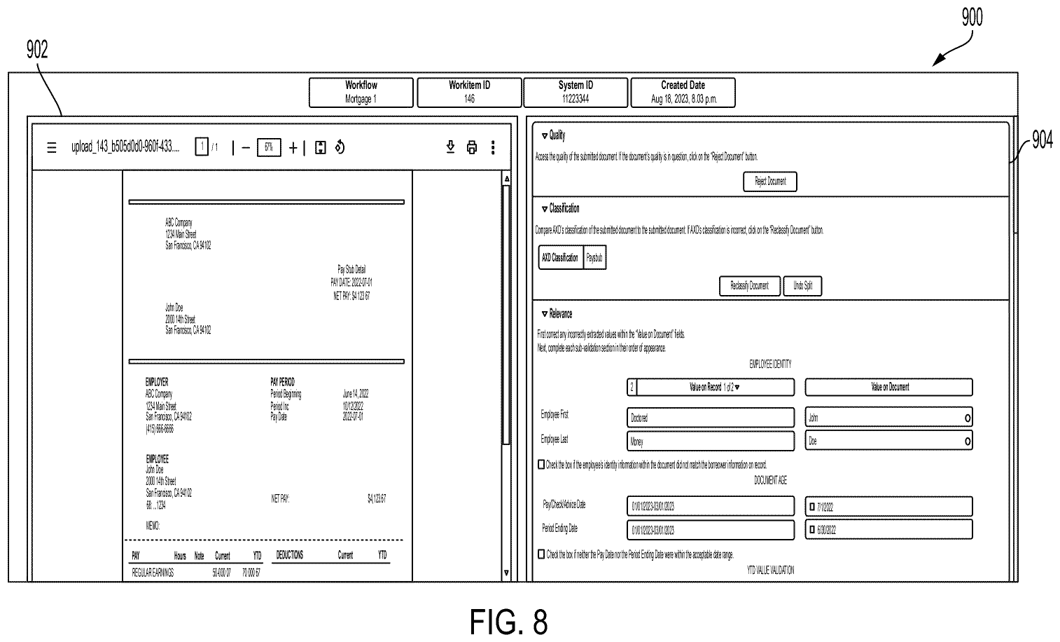

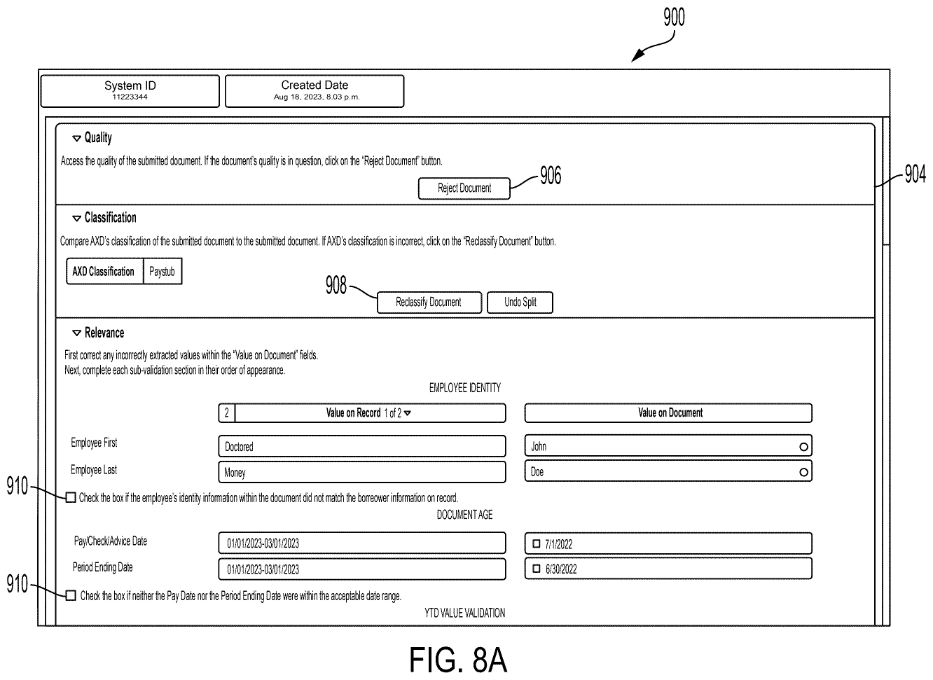

The workflow 211 further includes extraction transmission 220 to the data extraction platform 250 for sending the document 105 to the data extraction platform 250. APIs can facilitate transmission of the document files and extracted data between the data extraction platform 250 and the web server 200. The data extraction platform 250 extracts the data from the document 105 and provides the extracted data to the web-based server 200. The workflow 211 further includes data retention 224 for saving and/or storing the data provided by the data extraction platform 250 for each document. In various instances, the data can be transmitted to a cloud-based server 225 for storage. Thereafter, the workflow 211 comprises a human-in-the-loop (HITL) determination 226 to determine if the workflow 211 should proceed to a HITL validation 228. The HITL validation 228 provides a request to an administrator A via a user interface, such as the web-based user interfaces depicted in FIG. 8 and allows the administrator A to access the request and perform the validation of the extracted data. The threshold for requiring HITL validation can be adjusted in various instances.

In various instances, the workflow generator tool 210 can generate the workflow 211 based on data extraction rules, or configuration settings, related to thresholds of confidence for straight-through processing or human-in-the-loop processing. For example, the workflow 211 can proceed to HITL validation 228 in instances in which a threshold of confidence for the performed function (e.g. document unbundling, classification, extraction, image processing, etc.) is not met or otherwise satisfied. In other instances, the workflow 211 can bypass HITL validation 228 and proceed to straight-through processing.

The configuration settings include a predetermined confidence threshold for one or more of the document classification types. In various instances, each document classification type is associated with a predetermined confidence threshold. The executable code is to compare a threshold of confidence for the classification of the document to the predetermined confidence threshold for the document classification type transmitted to the data extraction server and either: (A) transmit a human-in-the-loop request to the web-based user interface based on the threshold of confidence subceeding the predetermined threshold of confidence, or (B) proceed with straight-through processing based on the threshold of confidence being equal to or greater than the threshold. The executable code is further to receive, via the web-based user interface, HITL validation(s) by the user, such as validation for the classification, for example.

HITL validation 228 can include a number of validations, including document quality validation 230 to determine if the document quality is acceptable, document classification validation 232 to determine if the document was classified correctly, multiple document validation 234 to determine if the document file includes multiple documents, document relevancy validation 236 to determine if the document is relevant to the workflow 211, and extraction correct validation 238 to confirm the extracted data was extracted correctly.

In various instances, the predetermined confidence threshold is 80%. In such instances, if the confidence for any field is less than 80%, a human-in-the-loop request is transmitted to the web-based user interface. In other instances, one or more fields can have a different predetermined confidence threshold.

In various instances, the predetermined confidence threshold can be less than 80%. For example, the predetermined confidence threshold can be 70-80%, 50-70%, or less than 50%. In still other instances, the predetermined confidence threshold can be greater than 80%. For example, the predetermined confidence threshold can be 80-90%, 90-95%, or greater than 95%.

The confidence of a particular data point can be based on a comparison to SOR data, for example. In various instances, the confidence of a particular data point can be based on data discrepancies and/or machine learning tools.

The human-in-the-loop can allow a user, e.g. an administrator at the enterprise, to accept, reject, and/or manually alter the results or output from the executable software generated by the workflow generator tool. In various instances, the human-in-the-loop can recover a document and recharacterize a data point, such as the classification. The user can reclassify and resubmit the document to a different model based on the reclassification.

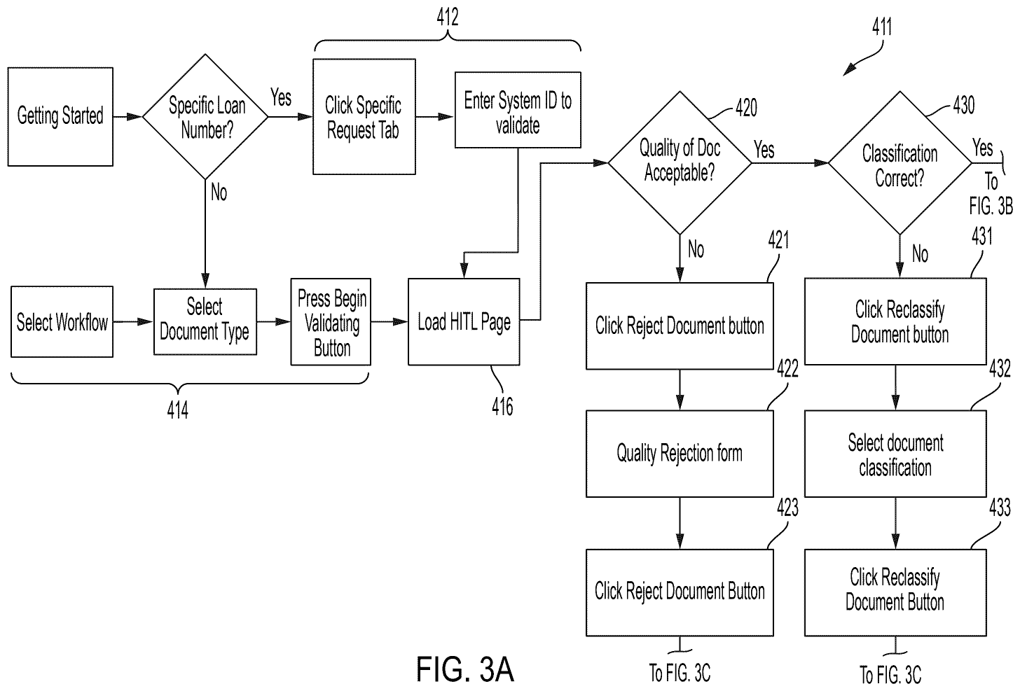

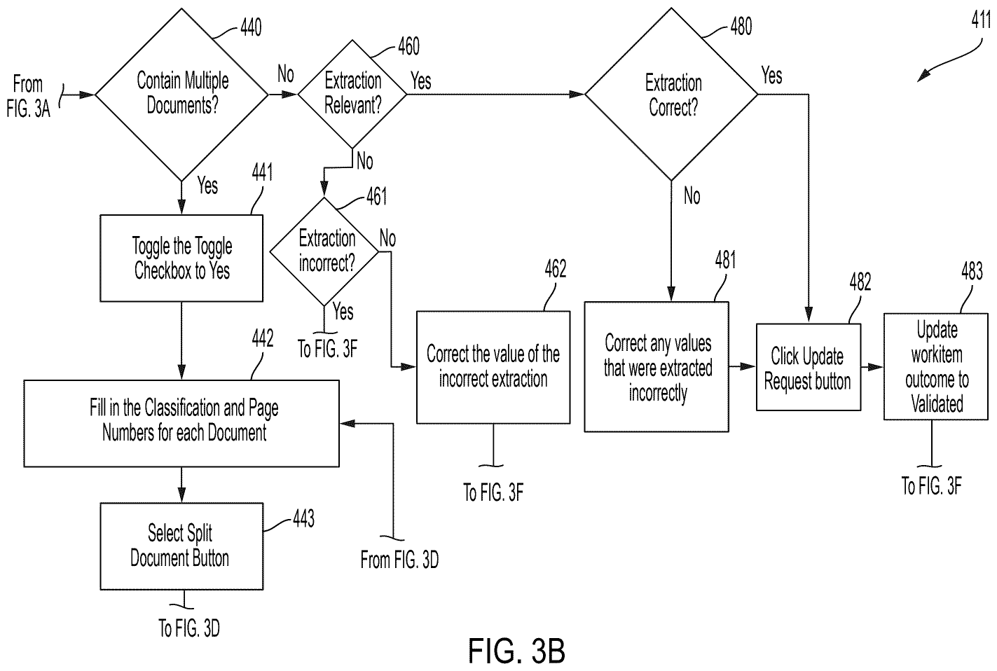

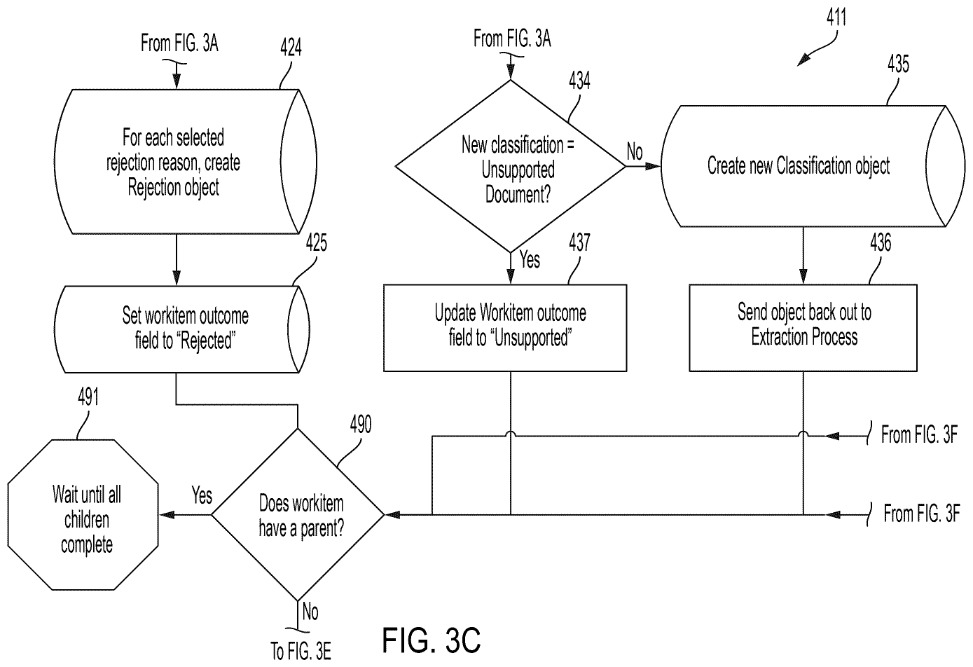

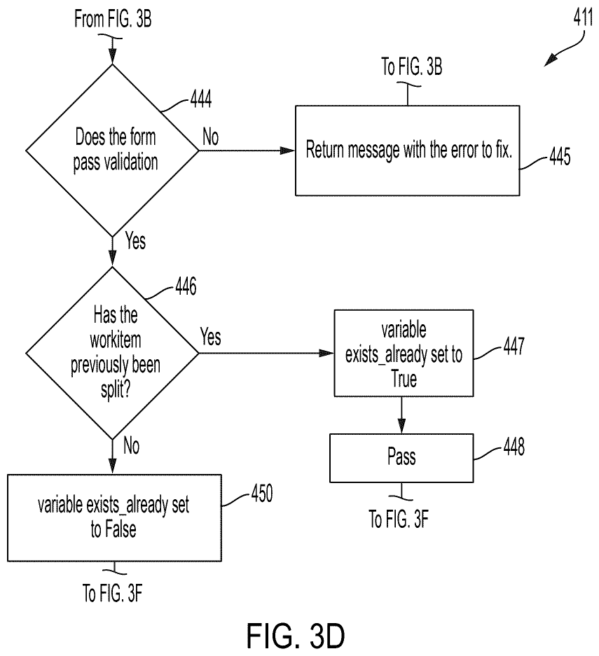

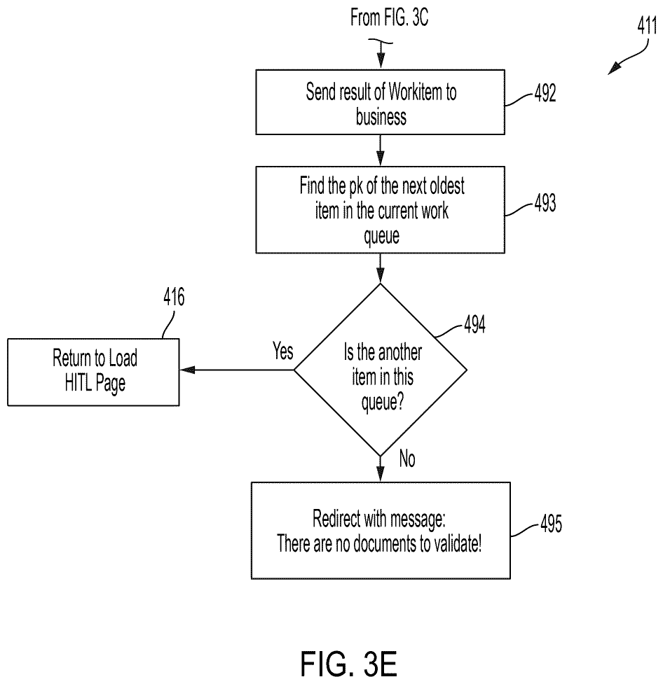

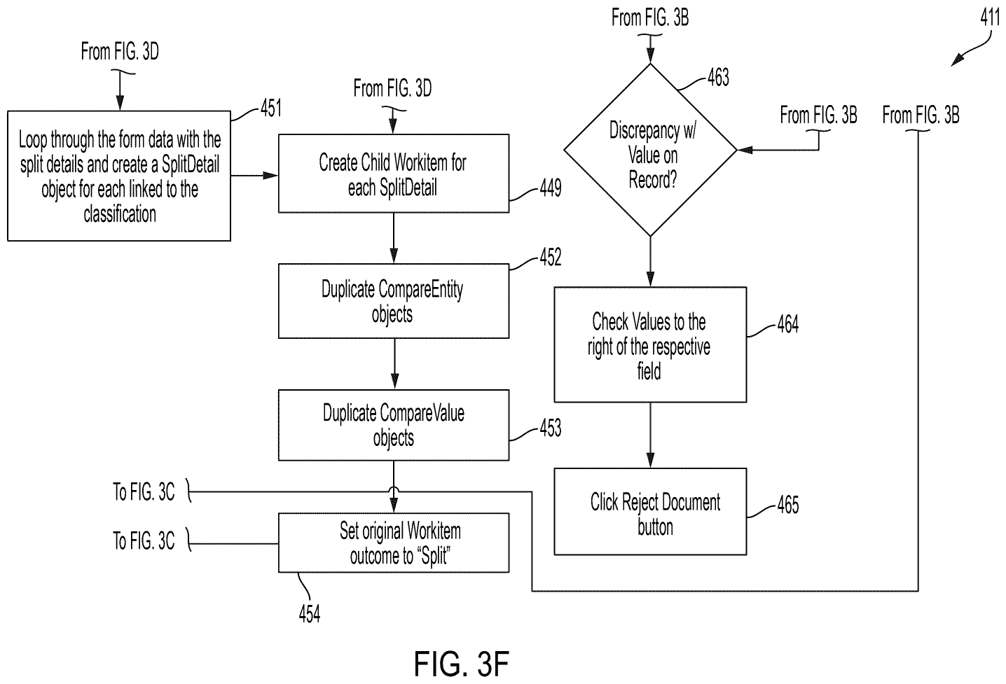

In various instances, the administrator, via the web-based user interface, validates one of more of the foregoing extracted data points along the HITL validation flow. Based on the administrator's feedback, the process can return to the task queuer 216 and/or to another location along the workflow 211 prior to the classification determinator 217. Furthermore, based on the administrator's feedback, the process can proceed to the data stream publisher 270, which can store and/or publish the output of the workflow 211 for downstream applications, such as the application 290. The application 290 can be configured to consume the data produced by the workflow generator tool 210 for downstream processes, for example. The data can be streamed in real-time, for example. Additional features of the HITL validation flow are further depicted in FIGS. 3A and 3B, for example. The data stream publisher 270 is configured to stream a document-rejected status or a document-accepted status and the associated data from the accepted document, for example. In various instances, the status can be streamed in real-time.

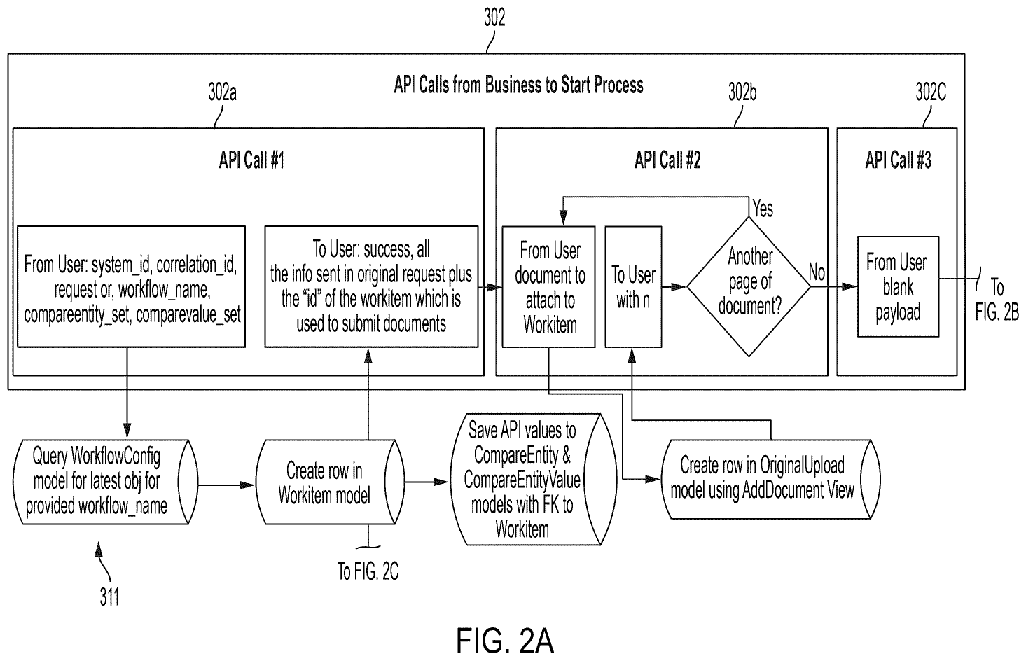

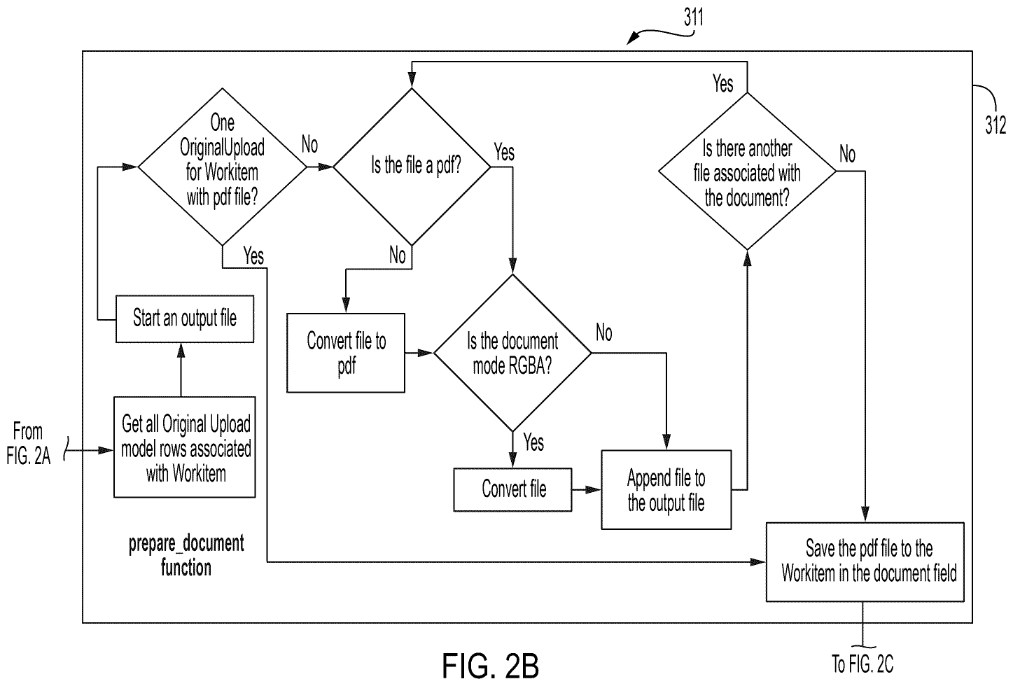

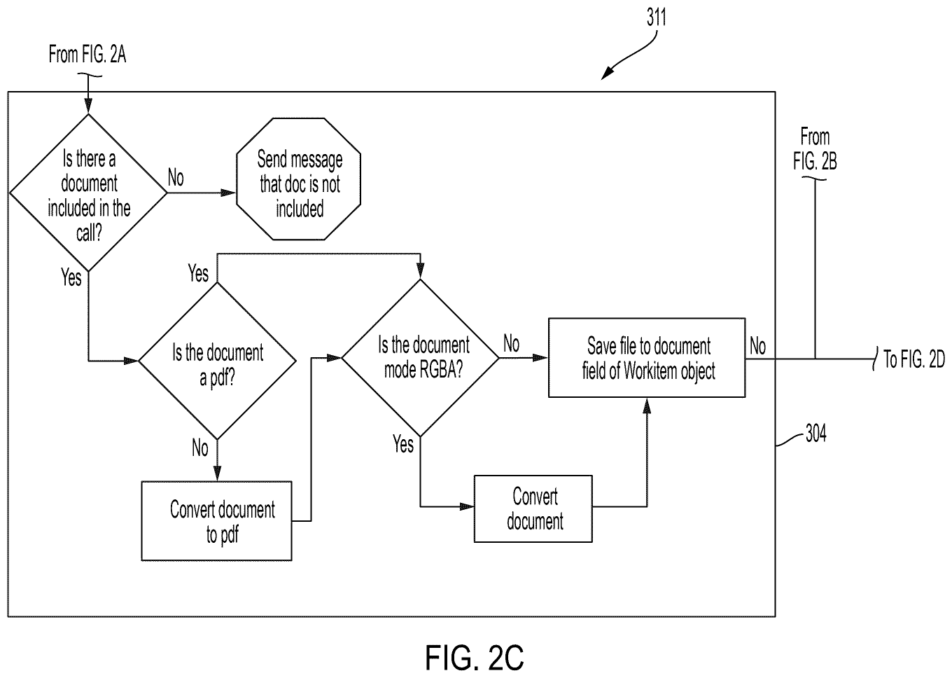

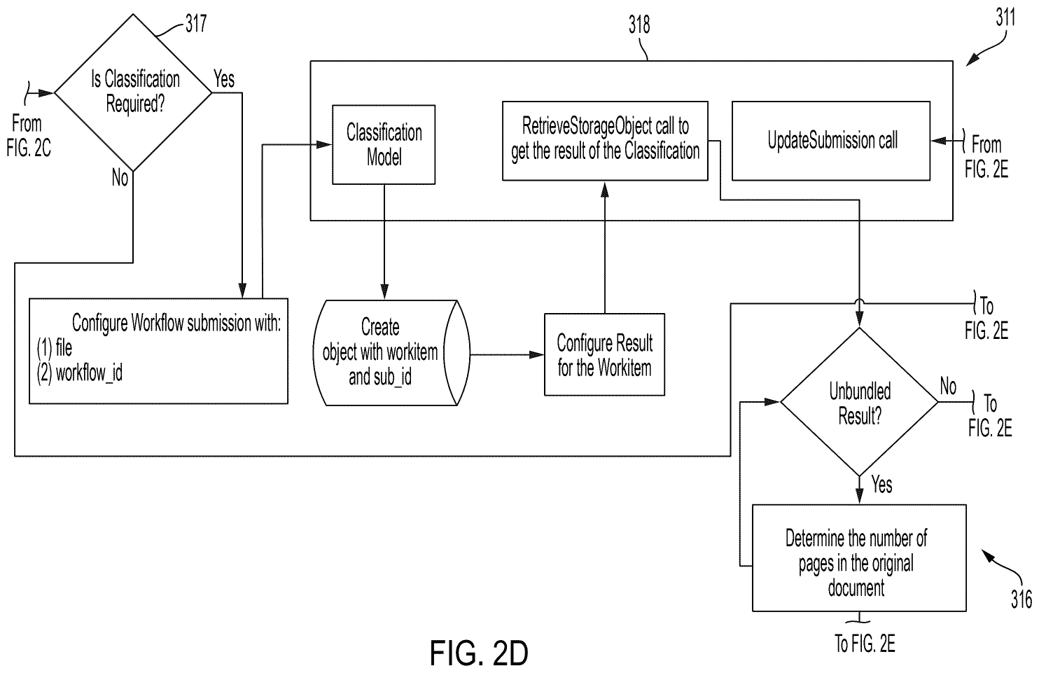

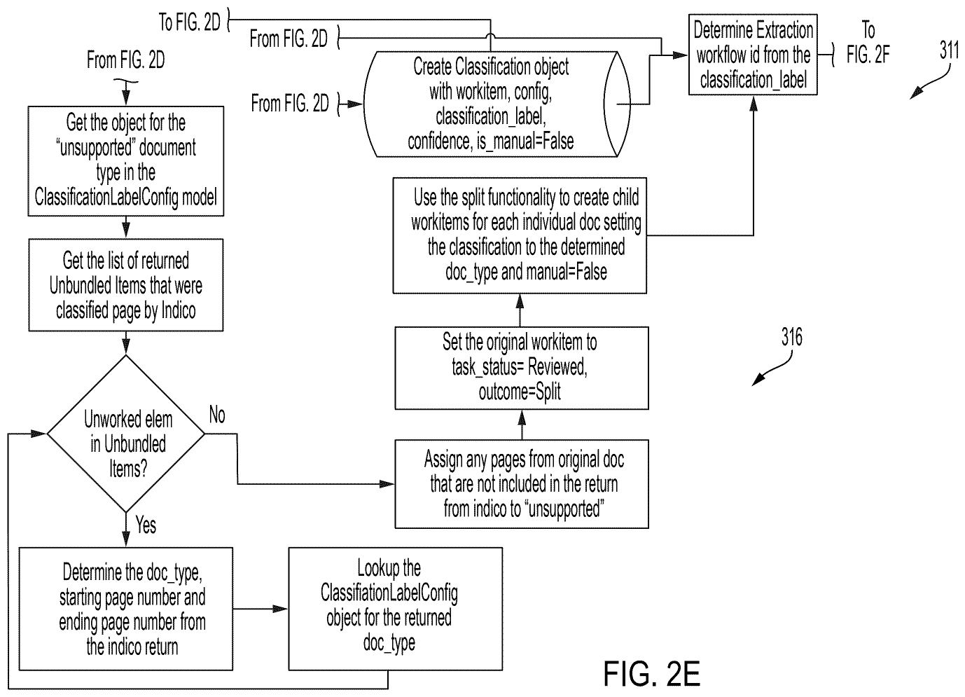

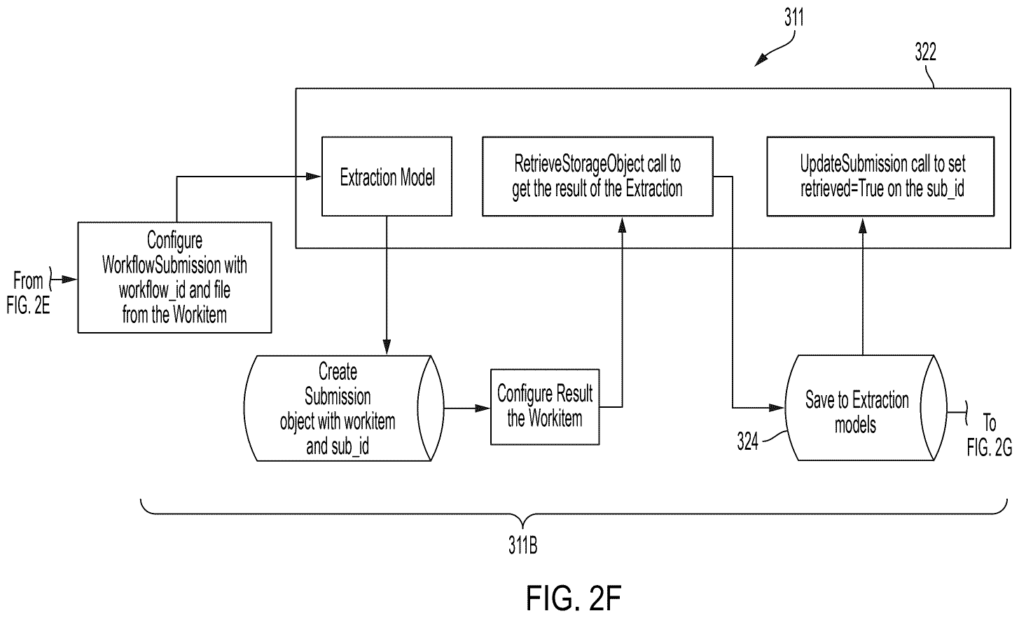

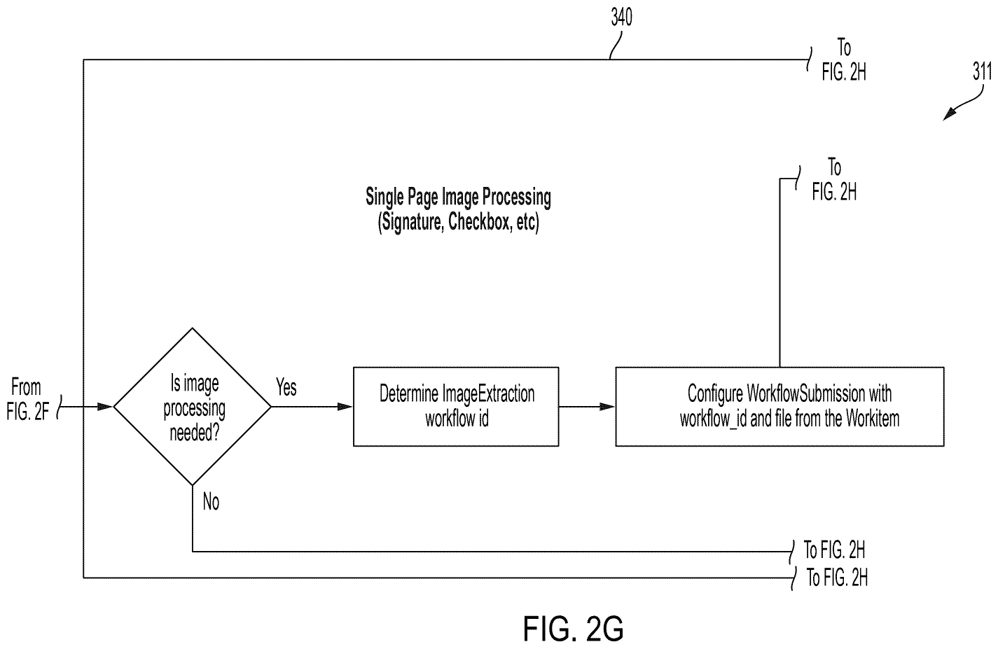

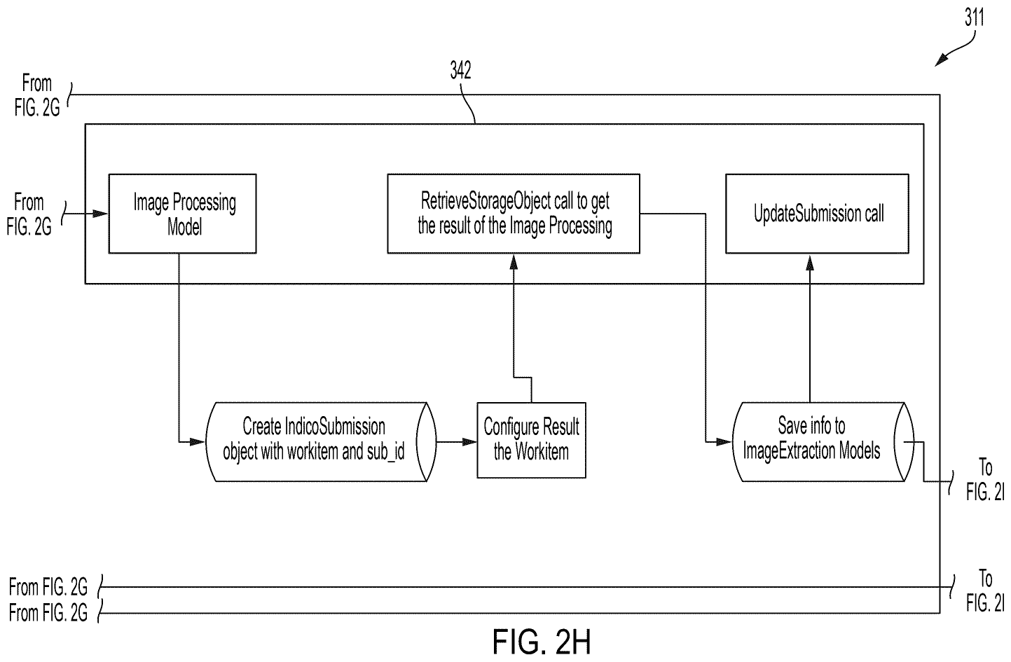

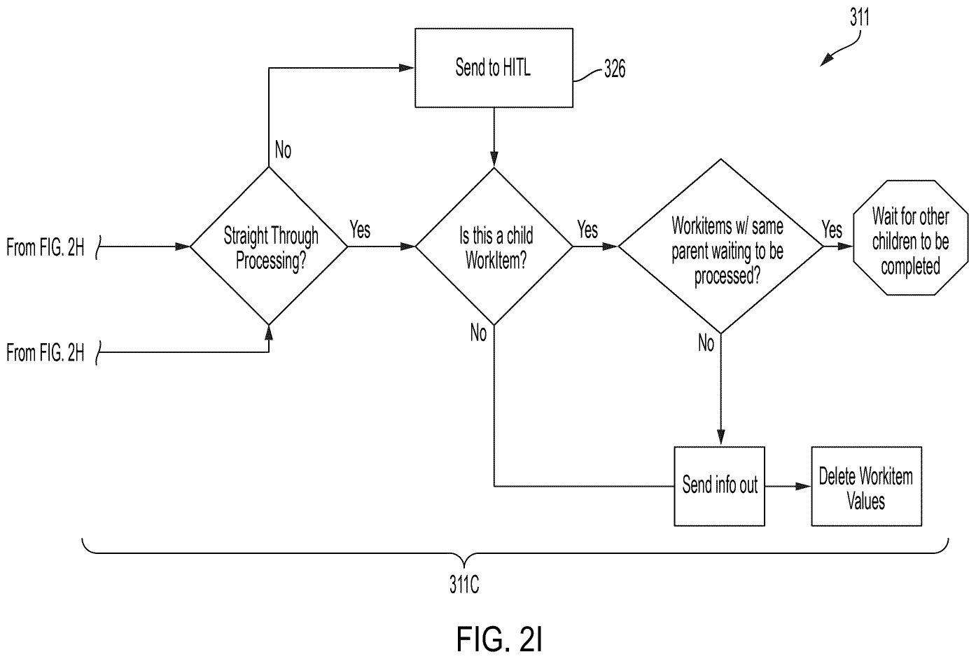

Data extraction flowcharts for a workflow 311 are further depicted in FIGS. 2A-2I. The workflow 311 is similar in many aspects to the workflow 211 and the reader will appreciate that various aspects of the workflow 311 can be incorporated into the workflow 211, for example. The workflow 311 can be generated by the workflow generator tool 210 of the web-based server 200 based on configuration settings input by an administrator via a web-based user interface provided by the tool 210. Furthermore, the workflow 311 includes API endpoints for communicating with a requesting application, a data extraction platform, and/or the data stream publisher.

In various instances, an API endpoint for initiating a workflow (e.g. the API endpoint 112 in FIG. 1) can coordinate and/or initiate a number of API calls between a requesting application and the workflow generator tool. For example, referring to FIG. 2A, the workflow 311 initially includes a series of calls 302 between the requesting application and an administrator. A first call 302a is from an administrator to the workflow generator tool to query the workflow generator tool for a particular workflow, a second call 302b is from the workflow generator tool to the administrator to attach the document to the particular work item, and a third call 302b is from the administrator to the workflow generator to submit the work item for the document preparation function. The first call 302a can further confirm document attachment 304 (FIG. 2C) and, in instances in which the work item includes a single attached document at the first call 302a, the workflow 311 can proceed to a classification determinator 317, which determines whether or not the attached document needs to be classified.

In various instances, the document classification type can be identified in the metadata and/or can be manually input by the administrator upon transmission of the document from the requesting application and/or via a HITL. In other instances, classification of the document can be required. In instances where classification is needed, the document is transmitted to a classifier 318 (FIG. 2D) of the data extraction platform for processing, which can be similar to classifier 218, for example.

In various instances, upon receipt of the image/metadata for the document via the API call(s) 302, the workflow 311 comprises a record creation 312 (FIG. 2B) to create a record for the document and then to the classification requirement determination 317 (FIG. 2D). For instances in which a document file includes multiple, bundled documents, the workflow 311 proceeds to a task queuer 316 (FIGS. 3D and 2E) to unbundle the documents within the document file for appropriate classification, and subsequent extraction, of each document within the file. In such instances, for each document in a document file, the executable code is to classify the document as one of the various document classification types, transmit the image of the document and document classification type to the data extraction server. Thereafter, in various instances, the extracted data is obtained by the extraction model 322 (FIG. 2F) based on the document and document classification type. The extracted data can then be provided to a downstream application, for example.

The data extraction platform completes the extraction via the extraction model 322 and transmits the extracted data back to the web-based server implementing the workflow 311. The workflow 311 further includes data retention 324 (FIG. 2F) for saving and/or storing the data provided by the data extraction platform for each document.

The workflow 311 further includes imaging processing 340 (FIGS. 2G and 2H). In particular, for documents requiring imaging processing, the configuration settings for the workflow 311 can be transmitted to the data extraction platform for extracting non-text data from documents, such as signature data, checkbox data, etc. The data extraction platform can locate the non-text data based on the configuration settings input by the operator (e.g. identify signature above the text “Insert Signature Here”). The workflow 311 further includes a human-in-the-loop (HITL) determination 326 to determine if the workflow 311 should proceed to a HITL validation, which can provide a request to an administrator via a user interface. Upon completion of the workflow 311, including waiting for all related and/or unbundled documents within a file to be processed, the workflow 311 proceeds to transmit the data to a data stream publisher, which can store and/or publish the output of the workflow for downstream applications, as further described herein. In various instances, the data stream publisher can stream a document-rejected status or a document-accepted status and the associated data from the accepted document.

A data extraction workflow 411 including a HITL module is depicted in FIGS. 3A-3F. The workflow 411 is similar in many aspects to the workflow 211 (FIG. 1). For example, the workflow 411 can be generated by the workflow generator tool 210 of the web-based server 200 based on configuration settings input by an administrator via a web-based user interface provided by the tool 210. Furthermore, the workflow 411 includes API endpoints for communicating with a requesting application, a data extraction platform, and/or the data stream publisher. The workflow 411 can be a continuation of the workflow 211 at HITL determination 226 (FIG. 1) and/or a continuation of the workflow 311 at HITL validation 326 (FIG. 2I).

The HITL validation workflow 411 includes an initial getting started process for loading the appropriate HITL user interface page based on identification of a specific identification number along a series 412 or, when the specific identification number is unknown or unavailable, stepping through a series 414 to identify the specific extraction to review via the HITL validation workflow 411. Thereafter, the web-based HITL user interface is loaded at step 416.

The HITL validation workflow 411 includes number of validations, which can be stepped through sequentially and/or selectively excluded from the process. For example, the workflow 411 includes a document quality validation 420 to determine if the document quality is acceptable, a document classification validation 430 to determine if the document was classified correctly, a multiple document validation 440 to determine if the document file includes multiple documents, a document relevancy validation 460 to determine if the document is relevant to the workflow 211, and an extraction correct validation 480 to confirm the extracted data was extracted correctly. In certain instances, the HITL validation workflow 411 includes a subset of the foregoing validations and, in various instances, includes additional validations.

Where the quality of the document is unacceptable at the document quality validation 430, the administrator, via the user interface, clicks the Reject Document button at step 421, which, in certain instances, loads a Quality Rejection Form for the user to select the reason(s) for rejecting the quality of the document at step 422 before again clicking the Reject Document button at step 423. For each selected rejection reason, a rejection object can be created at step 424. The work item outcome field can then be set to “Rejected” at step 425.

Where the classification of the document is unacceptable at the document classification validation 430, the administrator, via the user interface, clicks the Reclassify Document button at step 431, which, allows the administrator to select a document classification for the document at step 432 and click the Reclassify Document button at step 433. If the new document classification is unsupported, the outcome field for the work item is updated to unsupported at step 437. However, in instances in which the new document classification is supported, a new classification object is created at step 435 and the object is thereafter sent back through the document extraction flow, i.e. to a data extraction platform like the platform 250 (FIG. 1) for revised data extraction based on the updated document classification.

Where the document file includes multiple documents at multiple document validation 440, the administrator, via the user interface, toggles a checkbox, or other indicator to Yes at step 441, and then fills in the document classification and page number ranges for each document within the file at step 442. The administrator then selects the Split Document button at step 443. If the split document submission does not pass validation at step 444, an error message is provided to the administrator at step 445 to fix the error. If the split document submission passes validation at step 444, the workflow 411 continues to see if the work item was previously split at 446 and, if not, proceeds to step 451 to loop through the form data for each document from the file to create an entry for each document linked to the appropriate classification. If the work item was previously split, the process passes through the workflow creation process at steps 559, 452, 453, and 454.

Where the extracted data is not relevant at document relevant verification 460, the administrator, via the user interface, identifies the extraction as incorrect at step 461 and subsequently corrects the value of the incorrect extraction at step 462. Moreover, where there is a discrepancy between values on the record at step 463, for example, in comparison to SOR data for the enterprise, the values are checked at step 464 and the administrator selects the Reject Document button at step 465.

Finally, where the extracted data is not correct at extraction correct validation 480, the administrator, via the user interface, corrects any values that were extracted incorrectly at step 481. Thereafter, upon passing through the series of verifications 420, 430, 440, 460, and 480, the administrator, via the user interface, clicks the Update Request button at step 482 to update the work item outcome to Validated at step 483.

Each of the validations paths then proceeds to step 490, where the workflow 411 checks for parent files to the work item and, if a parent exists, is to wait for all of the children to complete the validation steps. At step 492, the results of the work item reviewed and evaluated via the HITL workflow 411 are sent to the appropriate business at step 492 and the process is then repeated if other work items are in the queue at step 494. In various instances, the oldest work items in the queue can be identified at step 493 and processed first. Upon completion of all the work items in the queue, the HITL workflow 411 can transmit a message to the administrator at step 495 indicating that there are no documents left in the queue to validate.

In various instances, the administrator, via the web-based user interface, validates or rejects and/or edits the foregoing extracted data points along the HITL workflow 411. Based on the administrator's feedback, the flow can return to the workflow 211 and/or 311 for publication of the extracted data via a data stream, for example. An exemplary web-based user interface for completing the HITL validation workflow 411 is depicted in FIG. 8, for example.

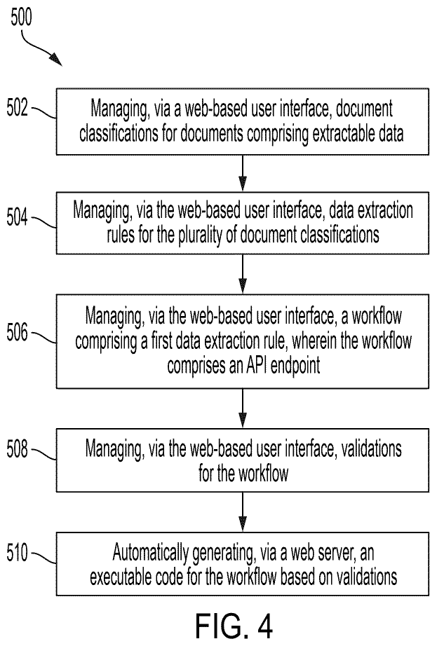

The various workflows disclosed herein, including workflows 211, 311, and 411, for example, can be generated automatically by a web-based server and/or workflow generator tool (e.g. work flow generator 210 in FIG. 1) thereof. An exemplary method 500 for automatically generating an executable code for a workflow is depicted in FIG. 4. The method 500 can be implemented by the web-based server 200 (FIG. 1), for example. In various instances, the web-based server provides a user interface for receiving administrator's inputs to facilitate management of the workflow. At block 502, the method 500 comprises managing document classifications for documents comprising extractable data. More specifically, managing document classifications comprises selecting at least one document type associated with each of the document classifications.

At block 504, the method 500 further comprises managing data extraction rules for the document classifications. For example, managing the data extraction rules comprises labeling data fields for extraction. In certain instances, extraction fields can be added for one or more document classifications and/or one or more workflows. To add extraction fields, a dictionary is added. In various instances, the dictionary can be formatted as follows:
Beginning and ending with square brackets;
Curly brackets surrounding each group, which define the Extraction Field; and
Additional items added as required by the use case.

For example, based on inputs to the data extraction rules by an administrator, the extraction fields can be labeled and defined by the executable code as follows:

```
[
  {
    “label”: “Field Name as returned from Indico”,
    “friendly_name”: “Field Name to show users”,
    “postextractioncleanup_set”: [{“name”: “remove_letters”},
    {“name”: “remove_whitespace”}],
    “retain”: 1
  },
  {
    “label”: “Field Name as returned from Indico”,
    “friendly_name”: “Field Name to show users”,
    “retain”: 1
  }
```

In one instance, “postextractioncleanup_set” is a list of dictionaries. The list of dictionaries can include one or more choices from the following list, for example:
func_date_mm/dd/yyyy
func_currency_commas
month_name_to_month_num
remove_digits
remove_letters
remove whitespace
remove_punctuation
remove_punctuation_except_period
whitespace_to_comma
remove_punctuation_except_period_and_dash; and
remove_punctuation_except_slash.

At block 506, the method 500 further comprises managing a workflow comprising a first data extraction rule. For example, the various workflows 211, 311, and 411 described herein can be managed based on configuration settings to set data extraction rule(s). The workflow managed at block 506 further comprises an API endpoint. In various instances, the workflow comprises a plurality of API endpoints between various applications and servers.

In various instances, managing the workflow at block 506 further includes entering a predefined confidence threshold for one or more extraction rules. The predefined confidence threshold can correspond to a threshold for implementing straight-through processing, for example. In such instances, the workflow can proceed to a HITL sub-process where the threshold is not satisfied, for example.

At block 508, the method 500 further comprises managing validations for the workflow. Managing the validations for a workflow at step 508 can include managing one or more of the following: a Base Value Check Validation, a Form Validation, a Data Check Validation, a Compare Value Validation, a Compare Entity Validation, and an At Least One Validation, which are further described herein.

At block 510, the method 500 further comprises automatically generating an executable code for the workflow based on the validations. In various instances, the executable code comprises containerized code. Exemplary code is further described herein.

Referring to FIG. 5, a web-based user interface 600 is depicted. The user interface 600 can be provided by a web server, such as the web server 200 (FIG. 1). In various instances, an administrator can manage a workflow (e.g. workflows 211, 311, 411) via the method 500 (FIG. 4) via the web-based user interface 600. For example, a workflow can be created and/or managed, e.g. step 506 in method 500, via the web-based user interface 600. In such instances, the user interface is provided upstream of the data extraction platform process and sets the rules for data extraction for a particular workflow.

The web-based user interface 600 includes a table 602 listing various categories 604, e.g. as columns, including Identification Number, Workflow Name, OEM Entitlement, Related Documents, Classification Configuration, Straight-through Processing Threshold, Related Compare Values, Related Compare Entities, and Action comprising a selectable icon 606. New workflows can be created and added by selection of the icon 608, for example. Although the table 602 is blank in FIG. 5, the reader will appreciate the cells can be selectively filled based on the workflow configurations. For example, Related Documents can identify the extractable documents for a particular workflow (e.g. paystubs, insurance forms, receipts, applications, W-2s). The reader will appreciate that alternative categories are contemplated and, in various instances, fewer or more categories can be included in the table 602 and/or web-based user interface 600.

In various instances, upon selection of the icon in the Action column, for example, the web-based user interface 600 can redirect the user to an editable interface. For example, editing of the Related Compare Entities items in the workflow is configured to, upon saving the workflow, cause the a workflow generator tool (e.g. 210 in FIG. 1) to automatically generate the following code:

```
{“compareentityconfig_set”: [
  {
    “name”: “borrower”,
    “compareentityfieldconfig_set”: [
      {
        “field_name”: “borrowerSsn”
      },
      {
        “field_name”: “borrowerFirstName”
      },
      {
        “field_name”: “borrowerLastName”
      }
    ]
  },
{
    “name”: “coborrower”,
    “compareentityfieldconfig_set”: [
      {
        “field_name”: “coborrowerSsn”
      },
      {
        “field_name”: “coborrowerFirstName”
      },
      {
        “field_name”: “coborrowerLastName”
      }
    ]
  },
]
```

As further described herein, managing the validations for a workflow at step 508 in method 600 can include managing one or validations (e.g. a Base Value Check Validation, a Form Validation, a Data Check Validation, a Compare Value Validation, a Compare Entity Validation, and an At Least One Validation, or Output Validation). Based on the validations input by the administrator via the web-based user interface, the workflow generator tool (e.g. 210 in FIG. 1) is configured to automatically generate the executable code.

The Base Value Check Validation is to set the fields shown in the human-in-the-loop process and defines the grouping of these fields. As an example, the workflow generator tool (e.g. 210 in FIG. 1) can automatically generate the following code based on the Base Value Check Validation inputs:

```
{“basecheckconfig_set”:
[
  {
    “extraction_field_name”: “BorrowerStreetAddress1”,
    “display_name”: “Employee Street Address 1”,
    “form_group”: “brown”,
    “sequence”: 0
  },
  {
  “extraction_field_name”: “AnnualSalary”,
  “display_name”: “Annual Salary”,
  “form_group”: “pink”,
  “sequence”: 0
  },
  {
  “extraction_field_name”: “RegularEarnings_PeriodAmount”,
  “display_name”: “Regular Earnings (Period Amount) 1”,
  “form_group”: “blue”,
  “sequence”: 0
  },
  {
  “extraction_field_name”: “RegularEarnings_PeriodAmount”,
  “display_name”: “Regular Earnings (Period Amount) 2”,
  “form_group”: “blue”,
  “sequence”: 1
  },
]
}
```

The Form Validation is to define the form rules, such as maximum string length, alphabetic only, numeric only, etc. Exemplary form rules and prompts are provided in the following table:

| Type | Type Description | Sample Prompt |
|---|---|---|
| empty | Required | Please enter the <insert field name> |
| | | value |
| maxLength[2] | Maximum Length of 2 | Max characters reached, please enter |
| | | under 2 characters for <insert field name> |
| maxLength[30] | Maximum Length of 30 | Max characters reached, please enter |
| | | under 30 characters for <insert field |
| | | name> |
| maxLength[100] | Maximum Length of | Max characters reached, please enter |
| | 100 | under 100 characters for <insert field |
| | | name> |
| maxLength[300] | Maximum Length of | Max characters reached, please enter |
| | 300 | under 300 characters for <insert field |
| | | name> |
| regExp[/\hat{ }[a-zA- | Alphabetic | Please enter only alphabetic characters |
| Z]*$/] | | for <insert field name> |
| regExp[/(?=.*?[0- | Numeric | Please enter only numeric characters for |
| 9])\hat{ }(([1-9][0- | | <insert field name> |
| 9]{0,2}(,[0- | | |
| 9]{3})*)\|[0- | | |
| 9]+)?([.][0- | | |
| 9]{1,2})?$/] | | |
| regExp[/\hat{ }[0- | SSN | <insert field name> must be in the form of |
| 9xX]{3}-[0-9xX]{2}- | | a SSN including the dashes |
| [0-9xX]{4}$/] | | |
| regExp[/\hat{ }[0- | yyyy | Enter a 4 digit year for <insert field |
| 9]{4}$/] | | name> |
| regExp[/\hat{ }[0- | mm/dd/yyyy | Enter a year in the format mm/dd/yyyy for |
| 9]{1,2}[/][0- | | <insert field name> |
| 9]{1,2}[/][0-9]{4}$/] | | |
| regExp[/(?=.*?[0- | Negative Numeric | Please enter a negative number |
| 9])\hat{ }-?(([1-9][0- | | |
| 9]{0,2}(,[0- | | |
| 9]{3})*)\|[0- | | |
| 9]+)?([.][0- | | |
| 9]{1,2})?$/] | | |

In instances in which a field requires more than one validation prompt, the field can be entered multiple times in the Form Validation section. For example, if a date field is required and must be entered in a date format, a first prompt is provided when that field is left blank and a second prompt is provided when the field has something other than a properly formatted date in it.

As an example, the workflow generator tool (e.g. 210 in FIG. 1) can automatically generate the following code based on the Form Validation inputs:

```
{“formvalidation_set”: [
  {
    “label_config_name”: “PayStub”,
    “extraction_field_name”: “PayDate”,
    “type”: “empty”,
    “prompt”: “Please enter the Pay/Check/Advice Date”
  },
  {
    “label_config_name”: “PayStub”,
    “extraction_field_name”: “PayDate”,
    “type”: “regExp[/\hat{ }[0-9]{1,2}[/][0-9]{1,2}[/][0-9]{4}$/]”,
    “prompt”: “Pay check advice date must be in the following
    format: mm/dd/yyyy”
  }
]
}
```

A Date Check Validation is to link an extraction field name with an upper bound and lower bound. These bounds can be defined in the workflow setup, as “CompareValues”, for example. As an example, the workflow generator tool (e.g. 210 in FIG. 1) can automatically generate the following code based on the Date Check Validation inputs:

```
{“datecheckconfig_set”: [
  {
    “title”: “Document Age”,
    “checkbox_label”: “Check the box if neither the Pay Date
nor the Period Ending Date were within the acceptable date range.”,
    “datecheckfieldconfig_set”:[
      {
        “lower_bound_value_name”: “PayDate”,
        “upper_bound_value_name”: “PayDate”,
        “extraction_field_name”: “PayDate”
      },
      {
        “lower_bound_value_name”: “PeriodEnding”,
        “upper_bound_value_name”: “PeriodEnding”,
        “extraction_field_name”: “PeriodEnding”
      }
    ]
  }
]
}
```

The Compare Value Validation is to checks extraction field names corresponding to a data extraction rule and a workflow. As an example, the workflow generator tool (e.g. 210 in FIG. 1) can automatically generate the following code based on the Compare Value Validation inputs:

```
{“comparevaluecheckconfig_set”: [
  {
    “compare_value_name”: “employerName”,
    “title”: “Employer Name”,
    “checkbox_label”: “”,
    “extraction_field_name”: “EmployerName”
  }
]
}
```

The Compare Entity Validation is to define the verbiage that will be shown in HITL for the compare entity values set up in the workflow section and links together the compare_entity_name (which is defined by field_name in the CompareEntity section of the Workflow setup) with the extraction_field_name. More specifically, the display_name can define the verbiage that will be shown in HITL for this value. As an example, the workflow generator tool (e.g. 210 in FIG. 1) can automatically generate the following code based on the Compare Entity Validation inputs:

```
{“compareentitycheckconfig_set”: [
  {
    “compare_entity_name”: “borrower”,
    “title”: “Employee Identity”,
    “checkbox_label”: “Check the box if the employee's
identity information within the document did not match the borrower
information on record.”,
    “compareentityfieldcheckconfig_set”: [
      {
        “compare_entity_field_name”: “borrowerFirstName”,
        “extraction_field_name”: “BorrowerFirstName”,
        “display_name”: “Employee First”
      },
      {
        “compare_entity_field_name”: “borrowerLastName”,
        “extraction_field_name”: “BorrowerLastName”,
        “display_name”: “Employee Last”
      }
    ]
  }
]
}
```

Managing the validations for a workflow at block 508 in the method 600 can further include managing at least one required output for at least one field. As an example, the workflow generator tool (e.g. 210 in FIG. 1) can automatically generate the following code based on the At Least One Validation inputs:

```
{“atleastonecheckconfig_set”: [
  {
    “name”: “ytd_value”,
    “title”: “YTD Value Validation”,
    “checkbox_label”: “Check the box if none of the above values
were present on the document.”,
    “atleastonefieldcheckconfig_set”: [
      {
        “extraction_field_name”: “GrossPay_YearToDate”,
        “display_name”: “Gross Earnings YTD Amount”
      },
      {
        “extraction_field_name”: “TotalEarnings_YearToDate”,
        “display_name”: “Total Earnings YTD Amount”
      },
      {
        “extraction_field_name”: “RegularEarnings_YearToDate”,
        “display_name”: “Regular (Earnings YTD Amount) 1”,
        “sequence”: 0
      },
      {
        “extraction_field_name”: “RegularEarnings_YearToDate”,
        “display_name”: “Regular (Earnings YTD Amount) 2”,
        “sequence”: 1
      },
          {
        “extraction_field_name”: “RegularEarnings_YearToDate”,
        “display_name”: “Regular (Earnings YTD Amount) 3”,
        “sequence”: 2
      },
    ]
  }
```

As further described herein, workflows generated by the workflow generator tool (e.g. 210 in FIG. 1) and managed by an administrator via a web-based user-interface, can include post-validation configuration settings, or rules, for processing of field data post-validation and post-extraction. For example, post-validation configuration settings can comprise a list of dictionaries, such as date reformatting, currency reformatting, and/or removal of certain digits, letters, whitespace, and/or punctuation, for example.

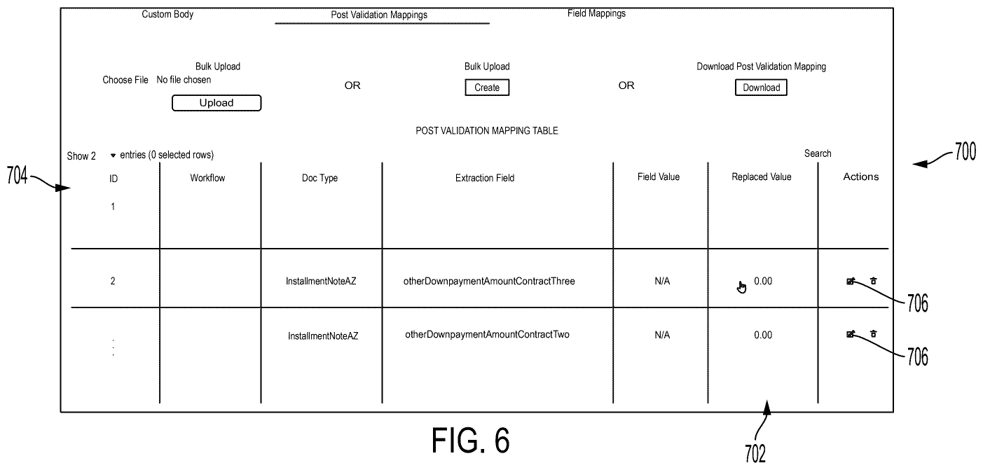

Referring to FIG. 6, a web-based user interface 700 for facilitating administrator management of post-validation configuration settings, or mappings, is depicted. The user interface 700 can be provided by a web server, such as the web server 200 (FIG. 1). The web-based user interface 700 includes a table 702 listing various categories 704, e.g. as columns, including Identification Number, Workflow Name, Document Type, Extraction Field, Field Value, Replaced Value, and Action comprising a selectable icon 706. The reader will appreciate that alternative categories are contemplated and, in various instances, fewer or more categories can be included in the table 702 and/or via the web-based user interface 700. The values and data in the cells of the table 702 are exemplary. For example, for a particular workflow, document type, and extraction field, the field value of N/A can be replaced with “0.00” based on the required formatting of the downstream application, for example. The post-validation configuration settings can be managed by an administrator via the user interface 700 and without requiring the administrator to write any code to change the format of an extracted value, for example.

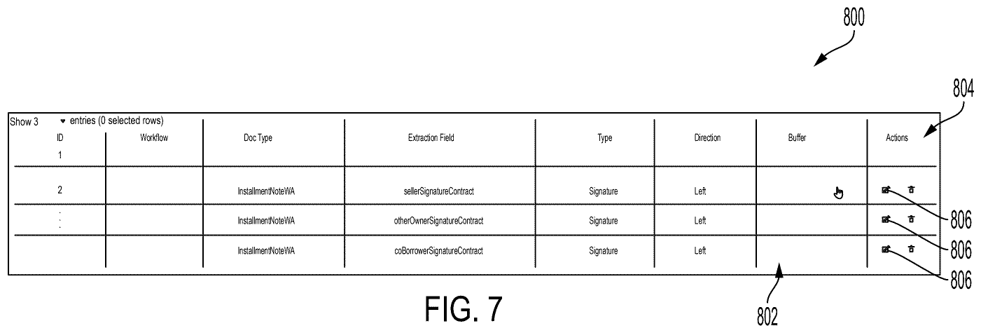

As further described herein, workflows generated by the workflow generator tool (e.g. 210 in FIG. 1) and managed by an administrator via a web-based user-interface, can perform imaging processing to extract non-text data from documents, such as signature data and checkbox data, for example. A data extraction platform utilized by the workflow can locate the non-text data based on the configuration settings input by the administrative via the web-based user interface. For example, the configuration settings can indicate the location of non-text data, such as a signature, relative to identifiable text, such as “Insert Signature Here.” Referring to FIG. 7, a portion of a web-based user interface 800 for facilitating administrator management of image processing configuration settings is depicted. The user interface 800 can be provided by a web server, such as the web server 200 (FIG. 1). The web-based user interface 800 includes a table 802 listing various categories 804, e.g. as columns, including Identification Number, Workflow Name, Document Type, Extraction Field, Type, Direction, Buffer, and Action comprising a selectable icon 706. The reader will appreciate that alternative categories are contemplated and, in various instances, fewer or more categories can be included in the table 802 and/or via the web-based user interface 800. The values and data in the cells of the table 802 are exemplary. For example, for a particular workflow, document type, and extraction field, an image of the signor's signature can be found to the left of an identifier, for example. The image processing configuration settings can be managed by an administrator via the user interface 800 and without requiring the administrator to write any code to locate the image, for example. If a signature block moves over time, the data extraction platform can still locate the signature by looking for the anchor point and the relative direction from that anchor point, for example. In instances in which machine learning may be used to identify a signature block, updating the configurating settings can more quickly update the data extraction model without requiring retraining of the machine learning model, for example.

In various instances, downstream of the data extraction platform, the extracted data can be provided to the administrator, or directly to a downstream application, for further processing. For example, the workflow can ultimately generate a web-based user interface displaying the extracted data and allowing the administrator to accept, reject, and/or manually alter the results. An exemplary HITL user interface 900 for reviewing the extracted data and accepting, rejections, and/or manually altering the data is depicted in FIGS. 8 and 8A. Referring to FIG. 8, a bifurcated view is provided in which a first window 902 depicts the processed document (e.g. document 105 in FIG. 1), and a second window 904 depicts the user interface for human-in-the-loop inputs. A heading 906 provides identifying information about the workflow, including the Workflow Name, Work Item Identification (e.g. Document Number), System ID, and Creation Date, for example. FIG. 8A depicts a close-up of the second window 904. The administrator reviewing the extracted data from the workflow can reject the extraction based on a number of criteria, such as quality, classification, and relevance. In certain instances, an administrator can reject an extraction based on the quality by selecting a first icon 908, can require reclassification of a classification by selecting a second icon 910. The administrator can also review the extracted data and edit or alter the values for the extracted value by selecting the icons under the relevance heading. In such instances, the HITL user interface 900 can receive inputs based on the administrator's review of the extracted data. As further described herein, the HITL interface can be automatically generated based on a threshold of confidence for the extracted data. In other instances, an administrator can require the HITL interface for particular workflows, classifications, and/or documents thereof.

The data extraction system herein can be implemented with computer devices, such as servers, with appropriately programmed software that, when executed, causes the computer devices to perform the functions described herein. The computer systems may comprise one or more processor cores and one or more computer memory units. The memory may comprise primary (memory directly accessible by the processor, such as RAM, processor registers and/or processor cache) and/or secondary (memory not directly accessible by the processor, such as ROM, flash, HDD, etc.) data storage, to store computer instruction or software to be executed by the processor core(s), such as the software for the data extraction system.

The software for the various computer systems described herein and other computer functions described herein may be implemented in computer software using any suitable computer programming language such as .NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

Example 1—A system comprises a data extraction server to extract data from documents and a web server in communication with a requesting application of an enterprise, a downstream application of the enterprise, and the data extraction server, the web server to provide a web-based user interface to receive configuration settings from an administrator of the enterprise, the web server comprising a workflow generator to automatically generate an executable code based on the configurations settings received by the web-based user interface. The executable code is to receive, from the requesting application, an image of a document; classify the document as one of a plurality of document classification types; transmit the document and document classification type to the data extraction server; receive, from the data extraction server, extracted data based on the document and document classification type; and publish the extracted data via a subscription service to the downstream application.

Example 2—The system of Example 1, wherein the executable code comprises containerized code.

Example 3—The system of any of Examples 1 and 2, wherein the executable code is written in a language selected from a group consisting of Python and JavaScript.

Example 4—The system of any of Examples 1-3, wherein the web server further comprises a memory storing the configuration settings, and wherein the configuration settings comprise extraction rules for the document classification type.

Example 5—The system of any of Examples 1-4, wherein, upon receipt of updated configuration settings from the web-based user interface, the work flow generator is to automatically update the executable code.

Example 6—The system of any of Examples 1-5, wherein the configuration settings comprise a predetermined confidence threshold for each document classification type, and wherein the executable code is to: compare a threshold of confidence for the classification of the document to the predetermined confidence threshold for the document classification type transmitted to the data extraction server; transmit a human-in-the-loop request to the web-based user interface based on the threshold of confidence subceeding the predetermined threshold of confidence; and receive, via the web-based user interface, a user validation of the classification.

Example 7—The system of any of Examples 1-6, wherein the workflow generator is to automatically generate an API endpoint based on the configurations settings to the web-based user interface input, and wherein the executable code comprises executable code for the API endpoint.

Example 8—The system of any one of Examples 1-7, the executable code comprising executable code for a first API endpoint to transmit a confirmation response to the requesting application upon receipt of the document and for a second API endpoint to publish the extracted data via the subscription service to the downstream application.

Example 9—The system of any of Examples 1-8, wherein the requesting application comprises a document upload tool to upload the image of the document and metadata associated with the document.

Example 10—The system of Example 9, wherein the document upload tool comprises a bulk file upload tool, wherein the workflow generator comprises a task queue, and wherein, for each document uploaded via the bulk file upload tool, the executable code is to: classify the document as one of N different document classification types, where N is an integer greater than 1; transmit the image of the document and document classification type to the data extraction server; receive, from the data extraction server, extracted data based on the document; and publish the extracted data via the subscription service to the downstream application.

Example 11—The system of any one of Examples 1-10, wherein the extracted data is published to the downstream application in real time.

Example 12—The system of any one of Examples 1-11, wherein the web server is to execute the executable code to extract data from the document based on the configuration settings.

Example 13—A method comprising receiving, from a web-based user interface of a web server, configuration settings comprising a plurality of document classification types and a predetermined confidence threshold for each document classification type and automatically generating, by a workflow generator of the web server, an executable code for a workflow based on the configurations settings received by the web-based user interface input, wherein the executable code for the workflow is to: receive, from the requesting application, an image of a document; classify the document as one of said plurality of document classification types; transmit, to a data extraction server, the image of the document and document classification type; receive, from the data extraction server, extracted data from the document; and publish the extracted data via a subscription service to a downstream application.

Example 14—The method of Example 13, wherein automatically generating an executable code based on the configuration settings further comprises automatically generating a plurality of API endpoints for the workflow.

Example 15—The method of any of Examples 13 and 14, further comprising: executing, by the web server, the executable code for the workflow to extract data from the document received from the requesting application; and receiving, via the web-based user interface, real-time feedback selected from a group consisting of acceptance feedback and rejection feedback.

Example 16—The method of any of Examples 13-15, wherein the configuration settings comprise a predetermined confidence threshold for each document classification type, and wherein the workflow generator of the web server is to automatically generate the executable code to: compare a threshold of confidence to the predetermined confidence threshold for the corresponding document classification type; and transmit a human-in-the-loop request to the web-based user interface based on the threshold of confidence subceeding the predetermined threshold of confidence.

Example 17—The method of any of Examples 13-16, further comprising receiving, via the web-based user interface, a user validation of extracted data.

Example 18—The method of any of Examples 13-17, further comprising, receiving, via the web-based user interface, a user validation of the document classification.

Example 19—The method of any of Examples 13-18, further comprising processing, by the web server, the extracted data to conform to the downstream application.

Example 20—The method of any of Examples 13-19, wherein the workflow generator of the web server is to automatically generate the executable code to visually identify data from the image of the document based on positioning of the data relative to an anchor location.

Example 21—A method, comprising managing, via a web-based user interface, a plurality of document classifications for documents comprising extractable data, wherein managing the plurality of document classifications comprises selecting at least one document type associated with each of the plurality of document classifications; managing, via the web-based user interface, a plurality of data extraction rules for the plurality of document classifications; managing, via the web-based user interface, a workflow comprising a first data extraction rule of the plurality of data extraction rules, wherein the workflow comprises an API endpoint; managing, via the web-based user interface, a plurality of validations for the workflow; and automatically generating, via a web server, a containerized executable code for the workflow based on the plurality of validations.

Example 22—The method of Example 21, wherein managing the plurality of data extraction rules comprises: labeling a plurality of data fields; and adding a dictionary for at least one of the plurality of data fields.

Example 23—The method of any of Examples 21 and 22, wherein managing the workflow comprises entering a predefined confidence threshold to selectively implement either straight-through processing or human-in-the-loop processing.

Example 24—The method of any of Examples 21-23, wherein managing the plurality of validations for the workflow comprises managing: a base value; a compare value; a form validation; a data check; and a comparison entity.

Example 25—The method of any of Examples 21-24, wherein managing the plurality of validations for the workflow further comprises managing a required output from at least one field.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various aspects have been described herein, it should be apparent that various modifications, alterations, and adaptations to those aspects may occur to persons skilled in the art with attainment of at least some of the advantages. The disclosed aspects are therefore intended to include all such modifications, alterations, and adaptations without departing from the scope of the aspects as set forth herein.

What is claimed is:

1. A system, comprising:
a data extraction server to extract data from documents; and
a web server in communication with a requesting application of an enterprise, a downstream application of the enterprise, and the data extraction server, the web server to provide a web-based user interface to receive configuration settings from an administrator of the enterprise, the web server comprising a workflow generator to automatically generate an executable code based on the configurations settings received by the web-based user interface, the executable code to:
receive, from the requesting application, an image of a document;
classify the document as one of a plurality of document classification types;
transmit the document and document classification type to the data extraction server;
receive, from the data extraction server, extracted data based on the document and document classification type; and
publish the extracted data via a subscription service to the downstream application.

2. The system of claim 1, wherein the executable code comprises containerized code.

3. The system of claim 1, wherein the executable code is written in a language selected from a group consisting of Python and JavaScript.

4. The system of claim 1, wherein the web server further comprises a memory storing the configuration settings, and wherein the configuration settings comprise extraction rules for the document classification type.

5. The system of claim 1, wherein, upon receipt of updated configuration settings from the web-based user interface, the work flow generator is to automatically update the executable code.

6. The system of claim 1, wherein the configuration settings comprise a predetermined confidence threshold for each document classification type, and wherein the executable code is to:
compare a threshold of confidence for the classification of the document to the predetermined confidence threshold for the document classification type transmitted to the data extraction server;
transmit a human-in-the-loop request to the web-based user interface based on the threshold of confidence subceeding the predetermined threshold of confidence; and
receive, via the web-based user interface, a user validation of the classification.

7. The system of claim 1, wherein the workflow generator is to automatically generate an API endpoint based on the configurations settings to the web-based user interface input, and wherein the executable code comprises executable code for the API endpoint.

8. The system of claim 1, the executable code comprising executable code for a first API endpoint to transmit a confirmation response to the requesting application upon receipt of the document and for a second API endpoint to publish the extracted data via the subscription service to the downstream application.

9. The system of claim 1, wherein the requesting application comprises a document upload tool to upload the image of the document and metadata associated with the document.

10. The system of claim 9, wherein the document upload tool comprises a bulk file upload tool, wherein the workflow generator comprises a task queue, and wherein, for each document uploaded via the bulk file upload tool, the executable code is to:
classify the document as one of N different document classification types, where N is an integer greater than 1;
transmit the image of the document and document classification type to the data extraction server;
receive, from the data extraction server, extracted data based on the document; and
publish the extracted data via the subscription service to the downstream application.

11. The system of claim 9, wherein the extracted data is published to the downstream application in real time.

12. The system of claim 1, wherein the web server is to execute the executable code to extract data from the document based on the configuration settings.

13. A method, comprising:
receiving, from a web-based user interface of a web server, configuration settings comprising a plurality of document classification types and a predetermined confidence threshold for each document classification type; and
automatically generating, by a workflow generator of the web server, an executable code for a workflow based on the configurations settings received by the web-based user interface input, the executable code for the workflow to:
receive, from the requesting application, an image of a document;
classify the document as one of said plurality of document classification types;
transmit, to a data extraction server, the image of the document and document classification type;
receive, from the data extraction server, extracted data from the document; and
publish the extracted data via a subscription service to a downstream application.

14. The method of claim 13, wherein automatically generating an executable code based on the configuration settings further comprises automatically generating a plurality of API endpoints for the workflow.

15. The method of claim 13, further comprising:
executing, by the web server, the executable code for the workflow to extract data from the document received from the requesting application; and
receiving, via the web-based user interface, real-time feedback selected from a group consisting of acceptance feedback and rejection feedback.

16. The method of claim 13, wherein the configuration settings comprise a predetermined confidence threshold for each document classification type, and wherein the workflow generator of the web server is to automatically generate the executable code to:
compare a threshold of confidence to the predetermined confidence threshold for the corresponding document classification type; and
transmit a human-in-the-loop request to the web-based user interface based on the threshold of confidence subceeding the predetermined threshold of confidence.

17. The method of claim 16, further comprising receiving, via the web-based user interface, a user validation of extracted data.

18. The method of claim 17, further comprising, receiving, via the web-based user interface, a user validation of the document classification.

19. The method of claim 13, further comprising processing, by the web server, the extracted data to conform to the downstream application.

20. The method of claim 13, wherein the workflow generator of the web server is to automatically generate the executable code to visually identify data from the image of the document based on positioning of the data relative to an anchor location.

21. A method, comprising:
managing, via a web-based user interface, a plurality of document classifications for documents comprising extractable data, wherein managing the plurality of document classifications comprises selecting at least one document type associated with each of the plurality of document classifications;
managing, via the web-based user interface, a plurality of data extraction rules for the plurality of document classifications;
managing, via the web-based user interface, a workflow comprising a first data extraction rule of the plurality of data extraction rules, wherein the workflow comprises an API endpoint;
managing, via the web-based user interface, a plurality of validations for the workflow; and
automatically generating, via a web server, a containerized executable code for the workflow based on the plurality of validations.

22. The method of claim 21, wherein managing the plurality of data extraction rules comprises:
labeling a plurality of data fields; and
adding a dictionary for at least one of the plurality of data fields.

23. The method of claim 21, wherein managing the workflow comprises entering a predefined confidence threshold to selectively implement either straight-through processing or human-in-the-loop processing.

24. The method of claim 21, wherein managing the plurality of validations for the workflow comprises managing:
a base value;
a compare value;
a form validation;
a data check; and
a comparison entity.

25. The method of claim 24, wherein managing the plurality of validations for the workflow further comprises managing a required output from at least one field.
